(19) United States
(12) Patent Application Publication
(10) Pub. No.: US 2026/0241349 A1
(43) Pub. Date: Aug. 20, 2026

(54) Two Stage Box Mixer

(71) Applicant: Tenneco Automotive Operating Company LLC, Northville, MI (US)

(72) Inventor: Manoj Kumar SAMPATH, Ann Arbor, MI (US)

(21) Appl. No.: 19/468,429

(22) Filed: Feb. 3, 2026

Related U.S. Application Data
(60) Provisional application No. 63/758,675, filed on Feb. 14, 2025.

(51) Int. Cl. B01F 25/313; B01F 23/213; B01F 25/23; B01F 35/00

(52) U.S. Cl. CPC B01F 25/3131; B01F 23/2132; B01F 25/23; B01F 35/55

(57) ABSTRACT

A mix box comprises a housing including a first inlet, a second inlet, and an outlet. A decomposition tube is positioned within the housing and defines a first chamber. A first flow path extends in a first direction from the first inlet through the decomposition tube. Gas exits the decomposition tube through a gap between the decomposition tube and the housing to flow along a second flow path in an opposite direction to the first flow path. A third flow path extends from the second inlet into the second chamber in the first direction. A mixer is positioned within the housing and includes an opening in communication with the second chamber. The second flow path and the third flow path intersect one another in opposite directions within the second chamber upstream the mixer.

### CROSS-REFERENCE TO RELATED APPLICATION

This application claims the benefit of U.S. Provisional Application No. 63/758,675, filed on February 14, 2025. The entire disclosure of the application referenced above is incorporated herein by reference.

### FIELD

The present disclosure relates to a mix box for an internal combustion engine exhaust aftertreatment system.

### BACKGROUND

This section provides background information related to the present disclosure which is not necessarily prior art.

Many vehicles equipped with internal combustion engines utilize exhaust aftertreatment devices for reducing nitrogen oxide emissions. Some of these systems include a reductant delivery system for transmitting reductant from a tank to the exhaust stream. A mixer may be useful for mixing the injected reductant with the exhaust before the reductant reaches a selective catalytic reduction device.

It may be beneficial to have a compact in-line mixer that delivers improved gaseous ammonia while providing improved exhaust gas flow performance with minimal system pressure loss. It may also be beneficial to provide a design that may be easily scaled for different applications and tuned for various engine operating conditions. For example, it may be desirable to provide a mix box including two different mixers with the first mixer being associated with reducing the droplet size of the injected reductant and the second mixer being operable to improve NH3 vapor diffusion.

### SUMMARY

This section provides a general summary of the disclosure and is not a comprehensive disclosure of its full scope or all of its features.

A mix box comprises a housing including a first inlet, a second inlet, and an outlet. A decomposition tube is positioned within the housing and defines a first chamber. A first flow path extends in a first direction from the first inlet through the decomposition tube. Gas exits the decomposition tube through a gap between the decomposition tube and the housing to flow along a second flow path in an opposite direction to the first flow path. A third flow path extends from the second inlet into the second chamber in the first direction. A mixer is positioned within the housing and includes an opening in communication with the second chamber. The second flow path and the third flow path intersect one another in opposite directions within the second chamber upstream the mixer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of an exemplary mix box constructed in accordance with the teachings of the present disclosure;

FIG. 2 is a perspective view of the mix box depicted in FIG. 1 having the housing in phantom line representation;

FIG. 3 is exploded perspective view of the mix box depicted in FIG. 1;

FIG. 4 is an end view of the mix box shown in FIG. 1;

FIG. 5 is a cross-sectional side view taken along line 5-5 shown in FIG. 4;

FIG. 6 is a perspective view of an alternate embodiment mix box;

FIG. 7 is an exploded perspective view of the mix box depicted in FIG. 6;

FIG. 8 is an end view of the mix box depicted in FIG. 6;

FIG. 9 is a cross-sectional side view taken along line 9-9 shown in FIG. 8;

FIG. 10 is a perspective view of an alternate embodiment integral atomizer and impingement plate;

FIG. 11 is an exploded perspective view of an alternative embodiment mix box;

FIG. 12 is a cross-sectional side view of the mix box shown in FIG. 11;

FIG. 13 is a cross-sectional side view of another alternate embodiment mix box;

FIG. 14 is a cross-sectional side view of another alternate embodiment mix box;

FIG. 15 is an exploded perspective view of another alternative embodiment mix box;

FIG. 15A is a perspective view of an alternative embodiment impingement plate;

FIG. 16 is a cross-sectional side view of the mix box depicted in FIG. 15;

FIG. 17 is a perspective of an alternate embodiment mix box having a single inlet;

FIG. 18 is exploded perspective view of the single inlet mix box depicted in FIG. 17;

FIG. 19 is a cross-sectional view taken through the mix box of FIG. 17;

FIG. 20 is a cross-sectional side view taken through an alternate embodiment mix box;

FIG. 21 is an exploded perspective view of the mix box depicted in FIG. 20; and

FIG. 22 is an exploded perspective view of another alternate embodiment mix box.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

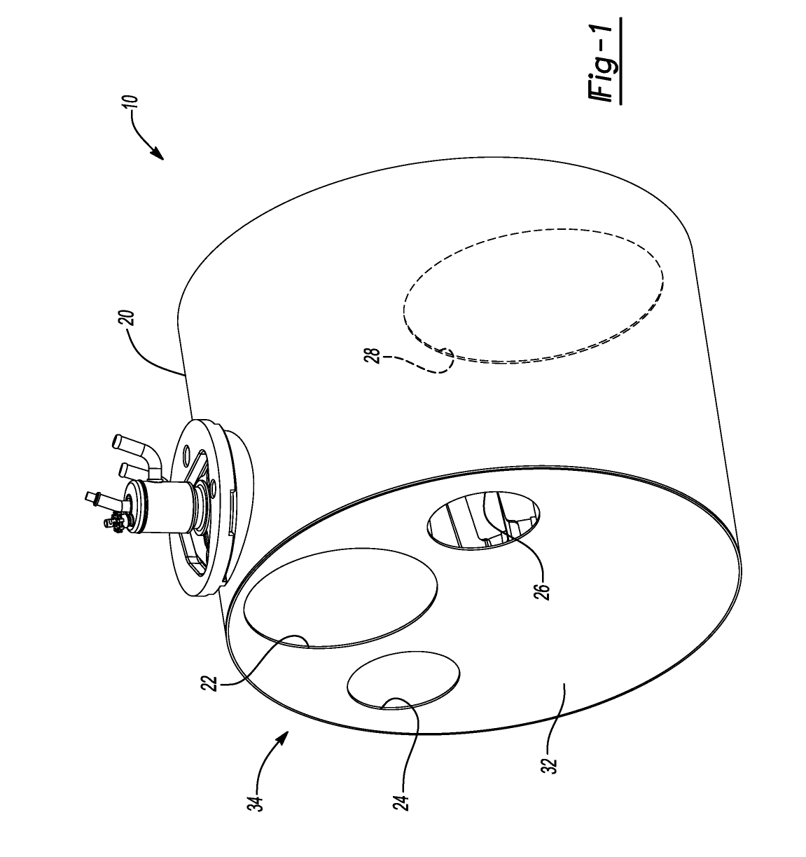

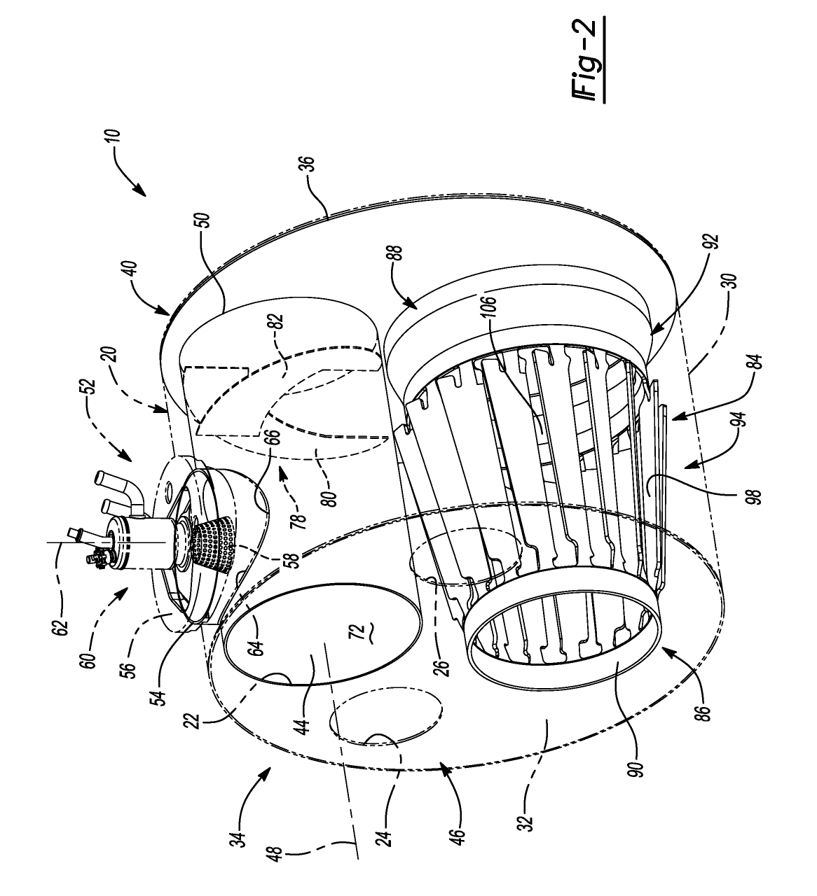

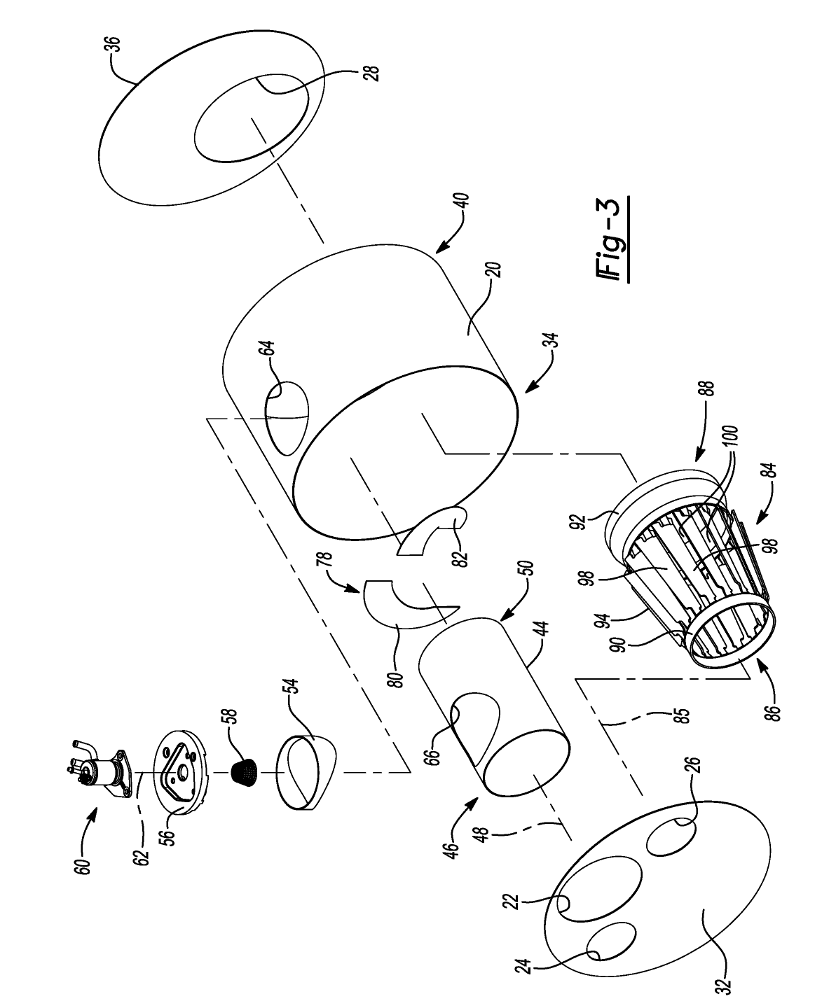

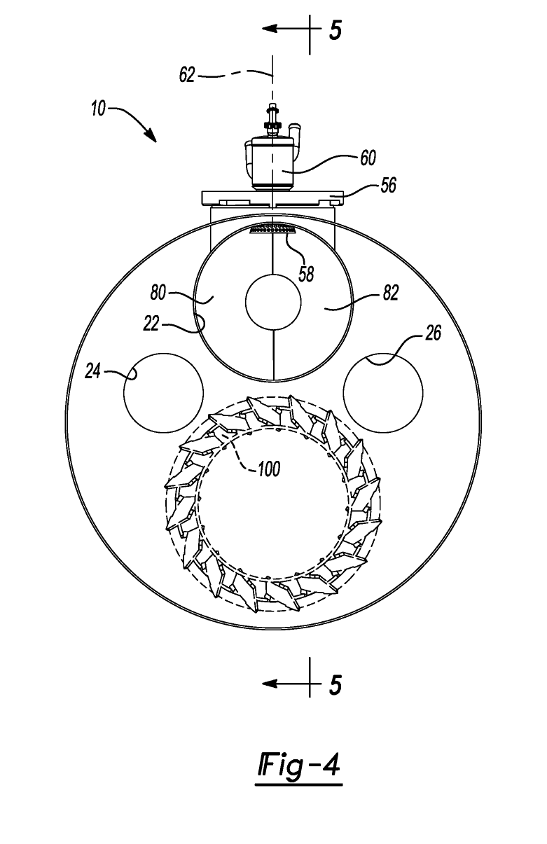

With reference to FIG. 1-5, an exemplary mix box 10 is a component in an exhaust system for an internal combustion engine. Mix box 10 is an exhaust after-treatment device operable to dose exhaust emitted from the internal combustion engine with a reagent before the exhaust passes through various other exhaust after-treatment components. For example, a urea exhaust treatment fluid may be dosed into the exhaust stream before the exhaust passes through a selective catalytic reduction (SCR) catalyst. The SCR catalyst is most effective when the exhaust is sufficiently mixed with the urea exhaust treatment fluid. Mix box 10 may be positioned downstream from one or more exhaust after-treatment components such as a diesel particulate filter. Mix box 10 includes a housing 20 including a first inlet 22, a second inlet 24, a third inlet 26, and an outlet 28. Housing 20 may be substantially cylindrically shaped including a sidewall 30 sealingly fixed to a first end cap 32 positioned a first end 34 of housing 20 in a second end cap 36 positioned at a second end 40 of housing 20. First end cap 32 and second end cap 36 are hermetically sealed to sidewall 30 using a process such as welding.

A decomposition tube 44 is positioned within housing 20 and includes a first end 46 fixed to first end cap 32 and aligned with first inlet 22 as it extends along an axis 48. Decomposition tube 44 includes an opposite second end 50 that is spaced apart from second end cap 36.

Housing 20 may optionally include an injector mount 52 including a tube 54 coupled to housing sidewall 30, a mounting plate 56, and an optional frustoconically shaped shield 58. An injector assembly 60 may be removably coupled to mounting plate 56 to selectively inject a reductant along an injection axis 62. Tube 54 extends through an aperture 64 extending through sidewall 30 and in fluid communication with an aperture 66 extending through decomposition tube 44 such that reductant may be injected from injector assembly 60 into an exhaust stream passing through first inlet 22 within a first chamber 72 at least partially defined by decomposition tube 44

In the embodiment depicted in FIGS. 1-5, decomposition tube 44 extends along axis 48 and injection axis 62 intersects axis 48 at a right angle. It should be appreciated that this geometrical arrangement is merely exemplary. Alternate positions of mounting injector assembly 60 are contemplated including mounting the injector assembly on first end cap 32 or on another component (not shown) on an injection axis that extends parallel to or is coaxially aligned with axis 48 of decomposition tube 44. In yet a further embodiment, the injection axis may be arranged at an oblique angle to axis 48 of decomposition tube 44.

A first stage mixer 78 is positioned within decomposition tube 44 at a position axially downstream from injection axis 62. A mixture of injected reductant and exhaust gas is presented to first stage mixer 78. As the reductant and exhaust gas pass by first stage mixer 78, the mixture is urged to rotate about axis 48 to breakup or atomize reductant droplets supplied from injector assembly 60. In the embodiment shown , first stage mixer 78 is configured as a partial helix mixer including a first curved blade 80 and a second curved blade 82.

A second stage mixer 84 is positioned within housing 20 extending along a longitudinal axis 85 that extends substantially parallel to axis 48. Second stage mixer 84 includes a first end 86 fixed to first end cap 32 and an opposite second end 88 fixed to second end cap 36. Second stage mixer 84 includes a hollow cylindrical first portion 90 and a flared hollow second portion 92. A third portion 94 is axially positioned between first portion 90 and second portion 92. Third portion 94 includes a plurality of rasps or blades 98 circumferentially spaced apart from one another. A plurality of gaps 100 are defined between adjacent pairs of blades 98. Third portion 94 is shaped as a frustoconical hollow member. It should be appreciated that first stage mixer 78 and second stage mixer 84 may be constructed using any number of different geometries and the configurations depicted in FIGS. 1-5 are merely exemplarily.

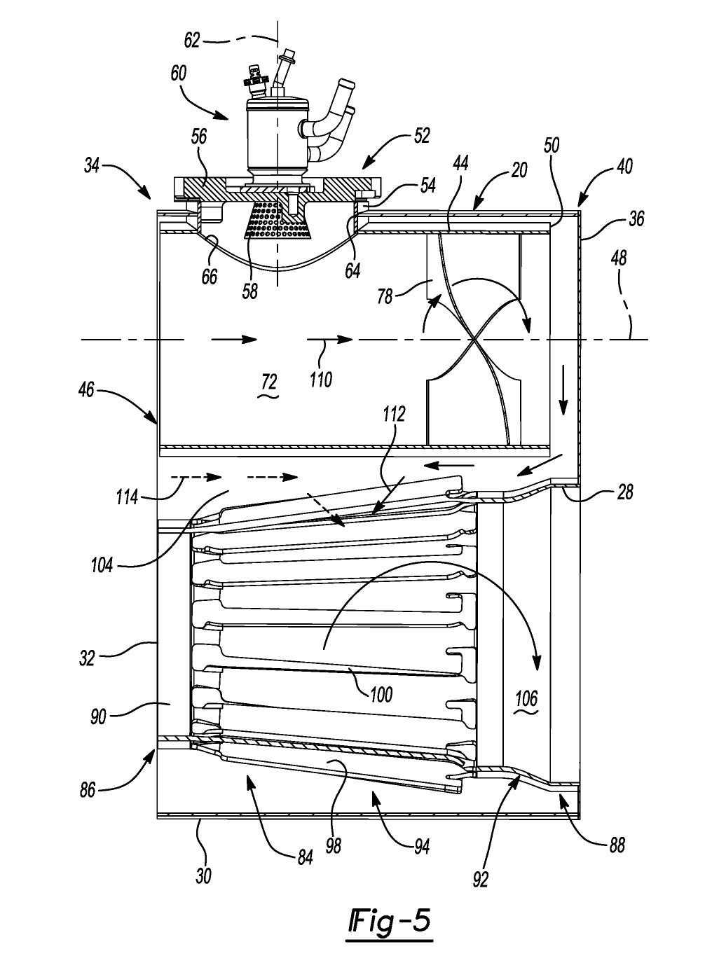

A second chamber identified at reference numeral 104 is disposed in a zone between decomposition tube 44 and second stage mixer 84. A third chamber 106 is defined as an interior volume at least partially defined by first portion 90, second portion 92 and third portion 94 of second stage mixer 84. With particular reference to FIG. 5, the exhaust flow into, within and exiting mix box 10 is depicted by several arrows. A first exhaust flow may be identified by first arrows 110 extending along axis 48 after passing through first inlet 22. Injected reductant mixes with the first exhaust flow within first chamber 72. First stage mixer 78 imparts a vortex flow path as indicated by the curved arrow overlying first stage mixer 78. A mixture of swirled exhaust and reductant exits second end 48 of decomposition tube 44. The mixture of exhaust and reductant impacts second end cap 36. The exhaust flow is then diverted 90 degrees through the gap that exists between second end 48 and second end cap 36. This exhaust flow then impacts an outer surface of second portion 92 of second stage mixer 84. This exhaust and reductant mixture now flows in an opposite direction substantially parallel to axis 48 as identified a second arrows 112.

Each of second inlet 24 and third inlet 26 provides an aperture allowing entry of bypass exhaust as represented by third arrows 114. Bypass exhaust gas flow indicated by third arrows 114 travels in the opposite direction as the reversed flow indicated by second arrows 112. These two flows intersect, interact, and mix within second chamber 104. The bypass flow through second inlet 24 and third inlet 26 beneficially maintains the temperature of decomposition tube 44 and second stage mixer 84 at a relatively high temperature during engine operation. The increased temperature improves mixing and minimizes pooling of any liquid injected reductant within decomposition tube 44.

The mixed opposed flows in second chamber 104 enter second stage mixer 84 through gaps 100. The angle of blades 98 urge a rotational flow as indicated by fourth arrows 116 positioned within third chamber 106. The swirling action within third chamber 106 facilitates diffusion of NH₃ vapor. Flow exiting outlet 28 now contains a suitable mixture of NH₃ and exhaust gas immediately upstream of a selective catalytic reduction device (not shown).

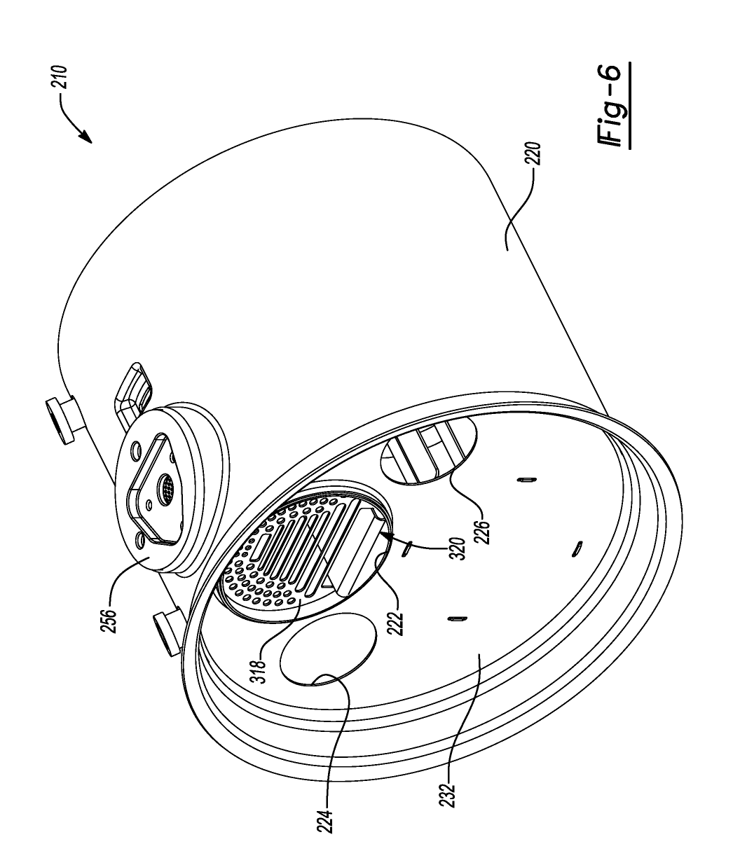

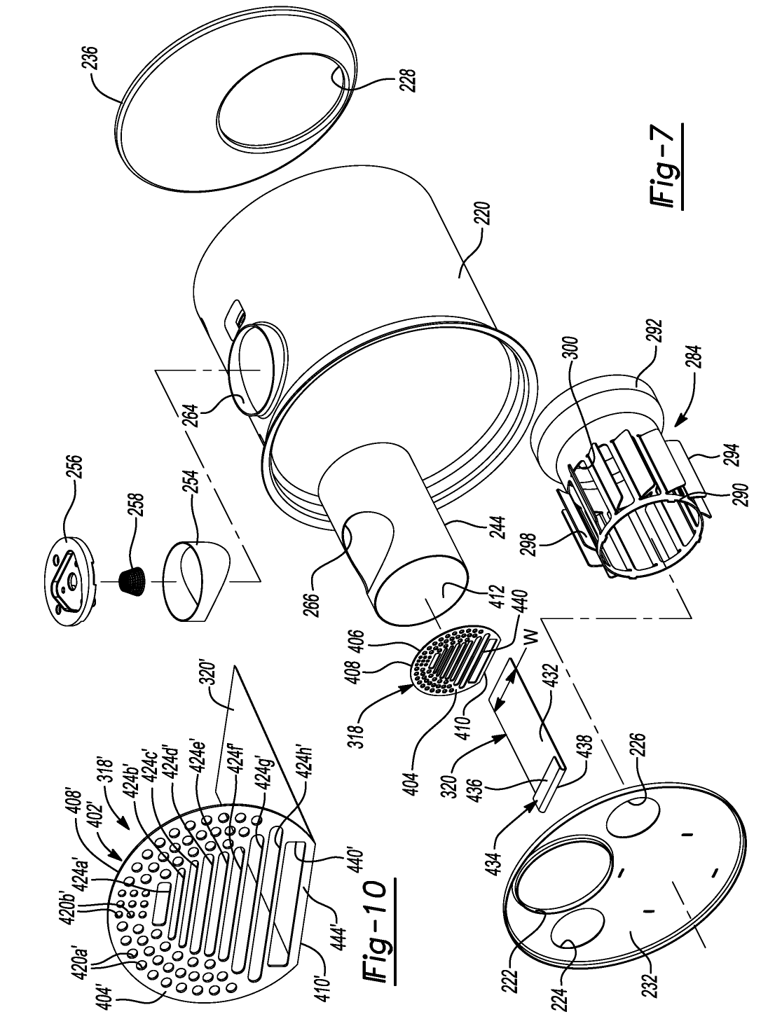

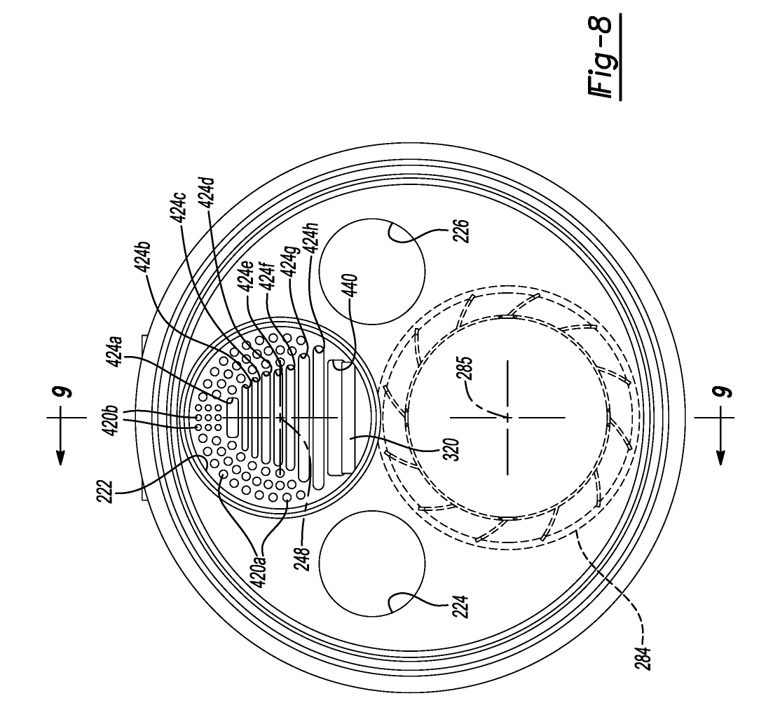

FIGS. 6-10 depict an alternate embodiment mix box 210. It should be appreciated that mix box 210 is substantially similar to mix box 10. In the interest clarity and brevity, similar elements will be identified with like reference numerals increased by 200. Mix box 210 differs primarily from mix box 10 in that first stage mixer 78 is removed while an atomizer 318 and an optional impingement plate 320 are positioned within decomposition tube 244. Second stage mixer 284 differs slightly from second stage mixer 84 but is positioned at substantially the same location within housing 220 and performs the functions previously described in relation to second stage mixer 84.

Atomizer 318 may be considered an exhaust flow modifier and is shaped as a substantially circular plate 402 having a planar upstream surface 404, a planar downstream surface 406 and an outer cylindrical surface 408 interconnecting the two planar surfaces 404, 406. A flat 410 is formed along a portion of outer cylindrical surface 408. A majority of cylindrical surface 408 is shaped and sized to mate with an inner surface 412 of decomposition tube 244. Flat 410 is spaced apart from inner surface 412. It should be appreciated that the circular shape of the majority of cylindrical surface 408 is merely exemplary and surface 408 may complement inner surface 412 regardless of the shape of the decomposition tube 244.

Atomizer 318 is fixed to inner surface 412 of decomposition tube 244 via a process such as welding at a position upstream from injector assembly 260. Exhaust flow is restricted from passing between outer cylindrical surface 408 and inner surface 412 except at a gap 417 between flat 410 and inner surface 412. As such, exhaust flow occurs through several apertures 418 extending through plate 402. Apertures 418 include various sizes and shapes. For example, a plurality of cylindrically shaped bores 420a are spaced apart from one another each having the same or a similar diameter. Bores 420b are also provided having a slightly smaller diameter. Bores 420a, 420b are generally positioned on the peripheral areas of plate 402 to partially restrict the flow of the exhaust gas therethrough and divert the flow through slots 424a-424h. Slot 424a is substantially rectangularly shaped having a height and a width. Each of slots 424b-824h may include a different width. Slots 424d-424f each have the same or a substantially similar height. Slots 424g-424h have the same or a substantially similar height.

Each of the slots extend substantially parallel to the other. The slots are designed such that the cross-sectional areas of the slots passing through plate 402 closest to the injector are smaller than the slot areas further from the injector. As the slot position becomes more distant from the injector, the cross-sectional area of each of the slots increases. The combination of bores 420a, 420b, and slots 424a-424h modifies the exhaust flow pattern upstream of the injector.

One of the prominent features of the modified flow exiting atomizer 318 includes multiple high velocity zones arranged in parallel sheets. Depending on the position and the shape of the various apertures 418, parallel sheets of exhaust gas flowing through slots 424a-424h will extend downstream from plate 402 different penetration lengths. By varying the cross-sectional areas, shapes, and sizes of apertures 418, the size and shape of the high velocity zones may be custom tailored.

It should be appreciated that bores 420a, 420b positioned at the uppermost central portion of plate 402 serve to restrict the flow of exhaust at locations adjacent the injector to protect the injected reductant spray from early exposure to exhaust gas. Typically, it is desirable to produce a substantially uniform distribution of atomized reductant across an upstream face of an exhaust treatment device such as an SCR. Accordingly, it may be desirable to have some of the reductant approach the sidewall of the conduit opposite injector assembly 260, but not touch it. If necessary, injector shield 258 may be implemented to further restrict exhaust flow interaction with the injected reductant until the reductant travels a sufficient distance away from the injector. Shield 258 may include apertures, louvers, flaps or the like to allow a portion of the exhaust gas to pass therethrough. A swirling gas pattern may be produced within shield 258.

A typical injector for spraying urea into an exhaust treatment system provides a conically-shaped pattern of urea droplets. Output from the injector may have droplets of different Sauter mean diameter (SMD). In general, droplets having a greater SMD have a greater mass and as such tend to resist deflection and atomization for a greater distance from the injector nozzle than droplets having a smaller SMD. Other injectors may produce two or more adjacent spray cones. Other injection systems may incorporate an air assist feature to simultaneously emit air and reagent from the injector. Each of these injectors may be used in combination with the atomizer of the present disclosure.

In the arrangement depicted in the Figures, the spray cone is allowed to develop until it reaches 20-30% of the exhaust conduit diameter before it substantially interacts with exhaust flow passing through one of slots 424a-424h. The slots are positioned, sized and shaped such that at positions near the injector, injected droplets having a lesser SMD will interact with the high velocity zone sheets closer to the injector to atomize the smaller droplets. Droplets having a larger SMD will penetrate the high velocity zone sheets closest to the injector but will be atomized by the high velocity zone sheets positioned further from the injector.

Through CFD modelling and incorporation of the present teachings, atomizer 318 may be custom tuned to operate in conjunction with a given injector or family or injectors to minimize or eliminate injected reductant droplets from impinging on the inner surface of the conduit. Depending on the geometry of the exhaust conduit, spray characteristics of the injector and the distance to the downstream exhaust treatment device, it may be beneficial to incorporate additional features such as tabs or louvers into the flow modifier.

Other modifications to atomizer 318 are contemplated and include varying the shape of the slots, varying the number of slots, changing the orientation of the slots relative to the position of the injector, as well as possibly including one or more additional plates positioned upstream or downstream of the previously described plate to further modify the exhaust flow. Atomizer 318 urges the droplets to break apart thereby promoting evaporation to minimize reductant impingement on the conduit or atomizer surfaces.

To further assure that the injected reductant is vaporized, optional impingement plate 320 may be positioned within decomposition tube 244 to extend substantially parallel to axis 248. Impingement plate 320 includes a substantially planar body portion 432 integrally formed with a hook portion 434 that includes a tang 436 and a trough 438. Body portion 432 extends substantially the entire length of decomposition tube 244.

Atomizer 318 includes an aperture 440 which receives tang 436 of impingement plate 320. A web 444 is positioned between aperture 440 and flat 410. Web 444 is positioned within hook portion 434. Body portion 432 is positioned adjacent to flat 410. A width W of impingement plate 314 corresponds to a chord on the inner diameter of decomposition tube 244 at the position of the impingement plate. Accordingly, first chamber 272 is defined by a majority of inner surface 412 of decomposition tube 244 and impingement plate 320. An additional bypass flow path is defined by the volume of decomposition tube on the opposite side of impingement plate 314 as first chamber 272. The auxiliary bypass flow path is identified at reference numeral 448.

Exhaust flowing through auxiliary bypass flow path 448 serves to maintain an elevated temperature of impingement plate 320 to minimize or entirely eliminate liquid reductant deposits. Trough 438 also provides an optional function of collecting any liquid reductant that may not be atomized when the mix box 210 is oriented in a vertical position. Exhaust gas flow passing through first chamber 272 as indicated by first arrows 310 and the flow through auxiliary bypass flow path 448 exit decomposition tube 244 and change direction ninety degrees based on the position and orientation of second end cap 336. Second chamber 304 receives the combined exhaust exiting first chamber 272 and auxiliary bypass flow path 448 as indicated by second arrows 312. Second chamber 304 also receives exhaust passing through first inlet 222 and second inlet 224 in the direction indicated by third arrows 314. Flow in the direction of second arrows 312 is in the opposite direction as flow along third arrows 314. The flow in the direction of second arrows 312 collides with the flow in the direction of third arrows 314.

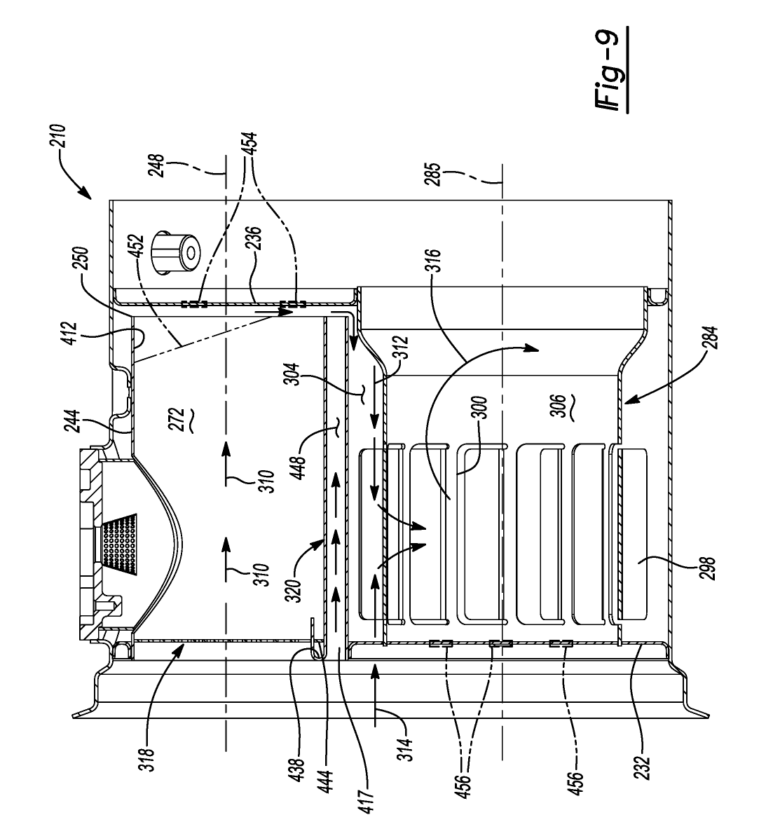

The amount and direction of the flow exiting decomposition tube 244 may be modified or custom tailored by changing the geometry of the second end 250. In FIG. 9, an exemplary chamfered end face 452 is depicted in phantom line representation. It should also be appreciated that the flow exiting decomposition tube 244 will be influenced by the geometry of second end cap 236 at the location of second end 250. While second end cap 236 is shown to include a substantially planar configuration in the figures, it is contemplated to include a concave or convex surface to direct the flow into second chamber 304. In yet another alternate configuration, flow exiting decomposition tube 244 may be altered by including optional apertures 454 extending through second end cap 236. The size and shape of the apertures may be varied to obtain desired flow characteristics. Another flow modifying alternate embodiment includes positioning apertures 456 on first end cap. Apertures 456 may be positioned in axial alignment with the location of third chamber 306 within second stage mixer 284. In this arrangement, some of the flow is purposefully allowed to bypass first chamber 272 and second chamber 304.

Second stage mixer 284 includes circumferentially spaced apart blades 298 positioned adjacent to gaps 300. In similar fashion to the previously described embodiment, bypass flow indicated by third arrows 314 mixes with exhaust and reductant flowing in the opposite direction, as indicated by second arrows 312. The mixture passes through gaps 300 and becomes a flow indicated by fourth arrows 316.

Second stage mixer 284 is substantially similar to second stage mixer 84 with the exception that third portion 94 is shaped as a frustoconical hollow member while third portion 294 is a hollow right circular cylinder. It should be appreciated that the density, size distribution, shape, blade twist, blade angle and other geometrical features of the mixers may vary to accommodate mixing design specifications without departing from the scope of the present disclosure. Use of wire mesh is also contemplated as a full or partial replacement for the mixer blades.

FIG. 10 depicts an alternate embodiment atomizer 318’ that may be implemented in lieu of atomizer 318 and impingement plate 320. Atomizer 318’ is a one-piece monolithic component preferably formed from a single metal sheet. Atomizer 318’ is substantially similar to atomizer 318 previously described. Accordingly, similar elements will be identified with like reference numerals including a prime suffix. Atomizer 318’ includes integral impingement plate portion 320’. Impingement plate portion 320’ is substantially similar to body portion 432 of impingement plate 320. Atomizer 318’ includes plate portion 402’ that is delimited from impingement plate portion 320’ by a 90-degree bend at flat 410’.

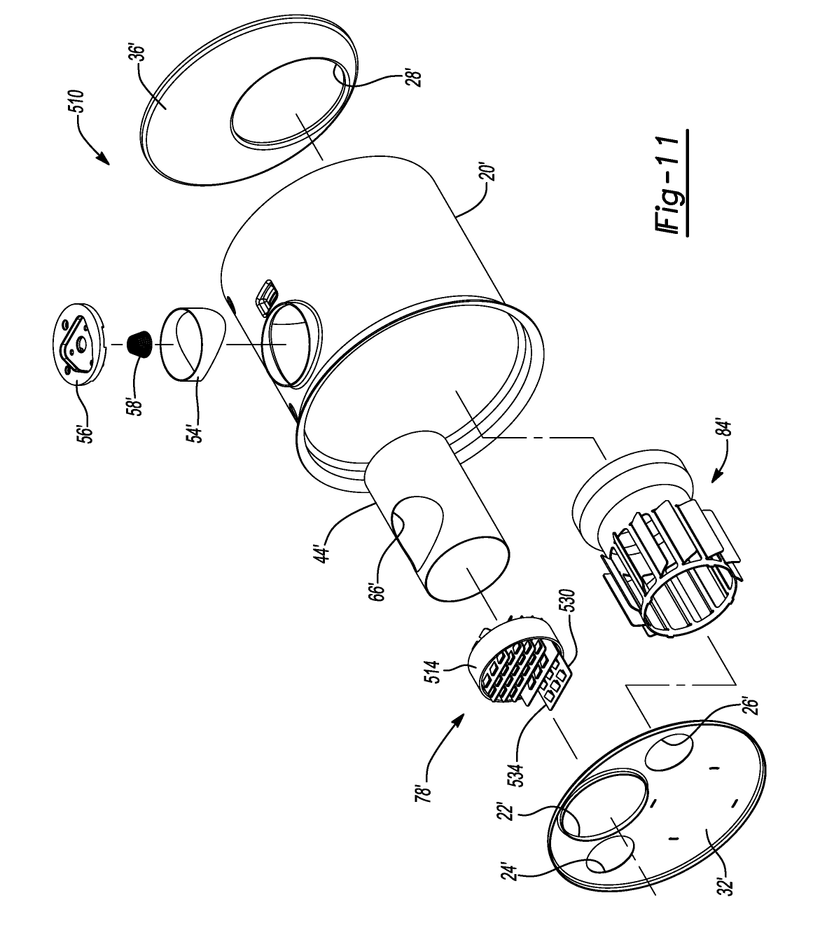

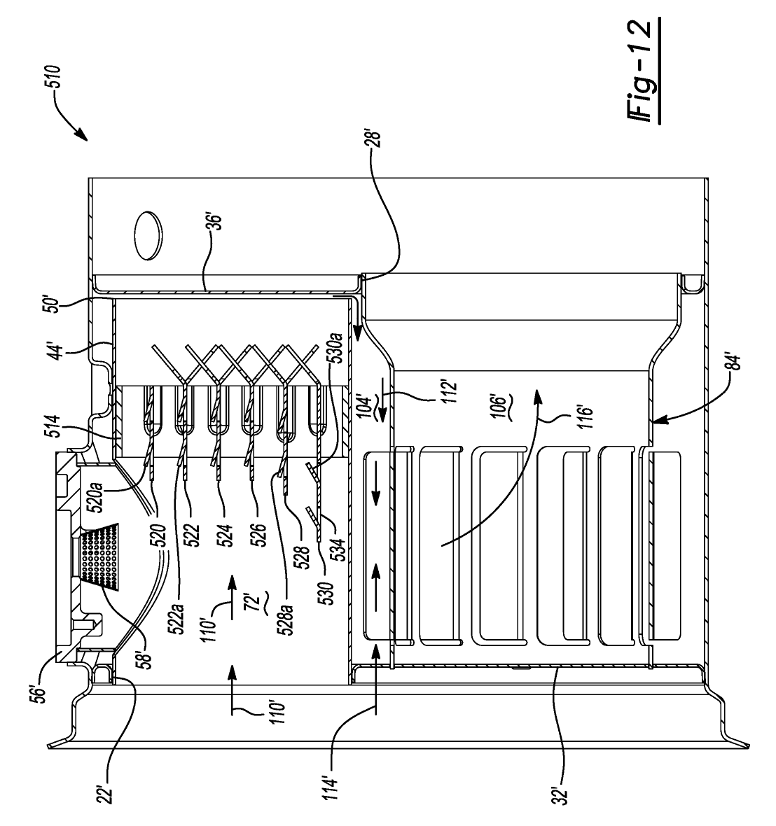

FIGS. 11 and 12 depicted another alternate embodiment mix box identified reference numeral 510. Mix box 510 is substantially similar to mix box 10. As such, similar elements will retain their previously introduced reference numerals including a prime suffix. The main difference between mix box 510 and mix box 10 includes an alternate embodiment first stage mixer 78’ replacing the helical blade first stage mixer 78. First stage mixer 78’ is substantially similar to a previously patented mixer depicted and described in US Patent No. 9,440,204 which is hereby incorporated by reference in its entirety.

First stage mixer 78’ includes a ring 514 in receipt of first through sixth mixing elements 520, 522, 524, 526, 528, and 530, respectively. Each of the mixing elements are substantially planar flat plates having fins extending at an angle relative thereto. Each of mixing elements 520–528 include upturned mixing fins identified with an “a” suffix. Mixing element 530 includes an outwardly extending deflection element 534 that may be function as an impingement plate. Mixing element 530 includes correction fins 530a that face the opposite direction as mixing fins 520a-528a. Mixing elements 522-530 also include a plurality mixing fins.

Importantly, mix box 510 includes a second end 50’ of decomposition tube 44’ spaced apart from second end cap 36’. As such, an opposing set of flows occurs as previously described in relation to the other embodiments concerning flow in the direction of second arrows 112’ exiting decomposition chamber 44 mixing and directly opposing bypass flow as indicated by third arrows 114’ with the mixing occurring within second chamber 104’. Second stage mixer 84’ is in receipt of the mixed flow and further imparts vortex or swirling flow as indicated by fourth arrows 116’.

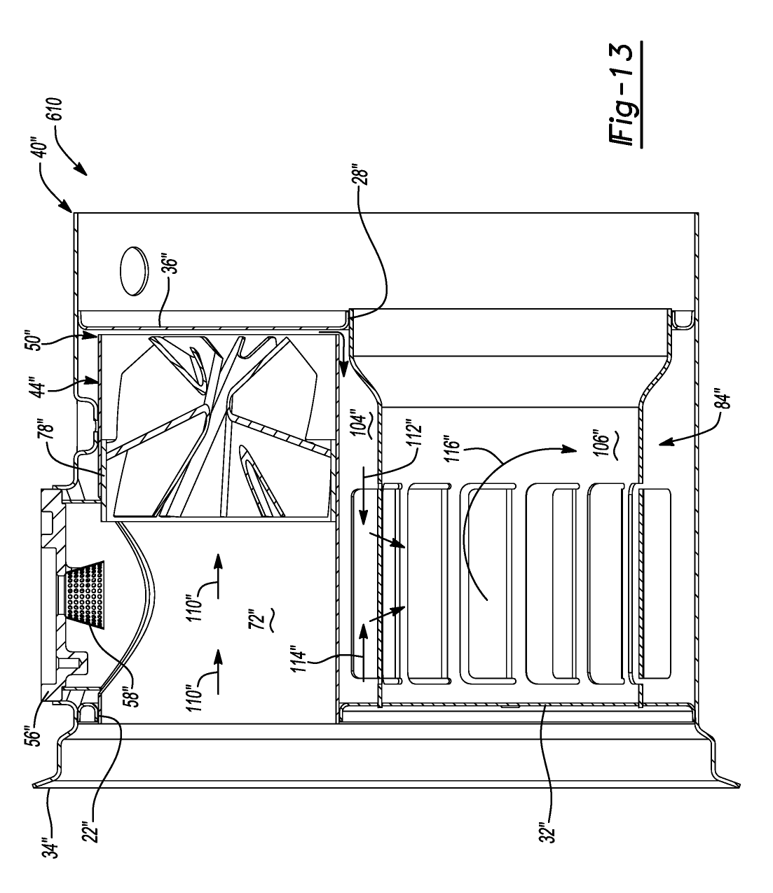

FIG. 13 depicts another alternate embodiment mix box identified at reference numeral 610. Mix box 610 is substantially similar to mix box 510. Similar elements will be identified with like reference numerals including a double prime suffix. Mix box 610 includes another alternate first stage mixer identified reference numeral 78”. First stage mixer 78” is substantially similar to first stage mixer 78 and first stage mixer 78’. FIG. 13 illustrates the flexibility of the three-chamber design with reverse flows opposing one another in second chamber 104”.

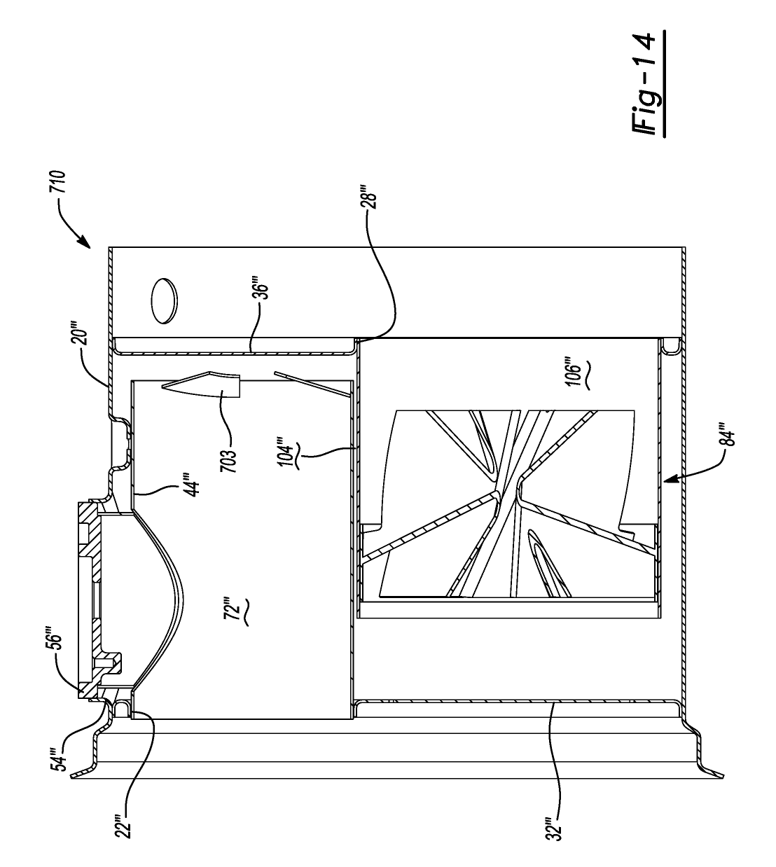

FIG. 14 depicts another alternate embodiment mix box 710. Mix box 710 is substantially similar to mix boxes 10, 510, and 610 as such, similar elements will be identified with like reference numerals including a triple prime suffix. Mix box 710 differs from mix box 610 in that second stage mixer 84” in FIG. 13 is replaced with second stage mixer 84’’’. Additionally, tabs or fins 703 are provided and positioned at the end of decomposition tube 44’’' to provide a mixing function. Tabs or fins may be alternatively or additionally added to the downstream end of second stage mixer 84’’. Similar tabs or fins may be added to the components of any one of the embodiments of this disclosure.

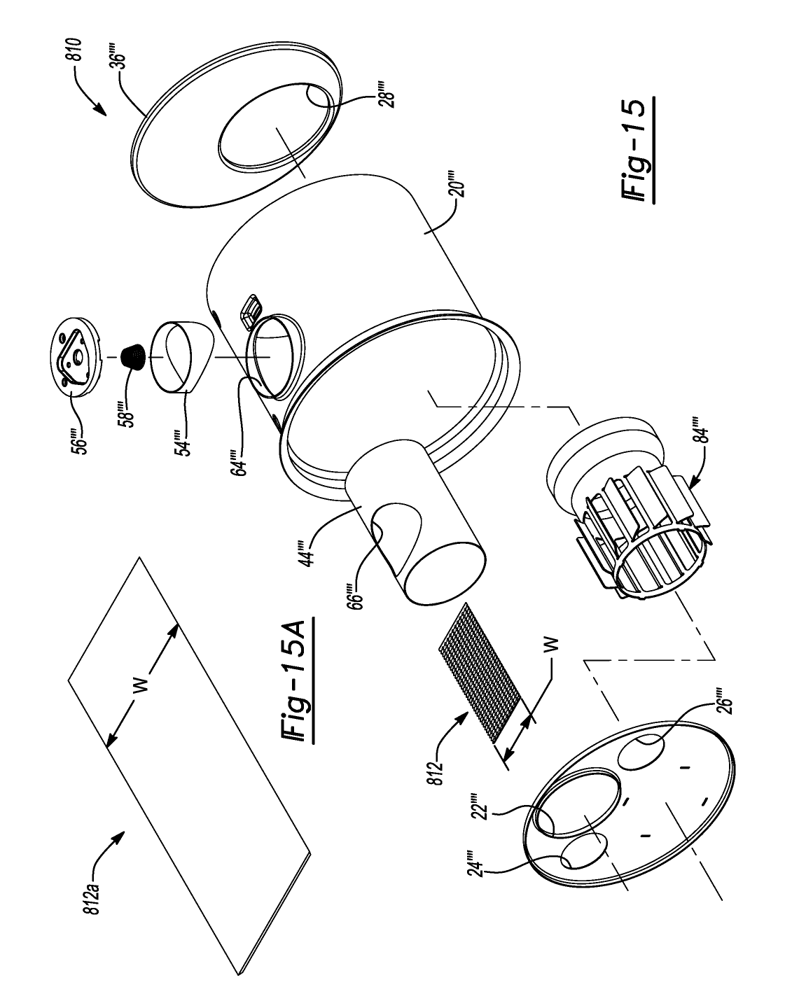

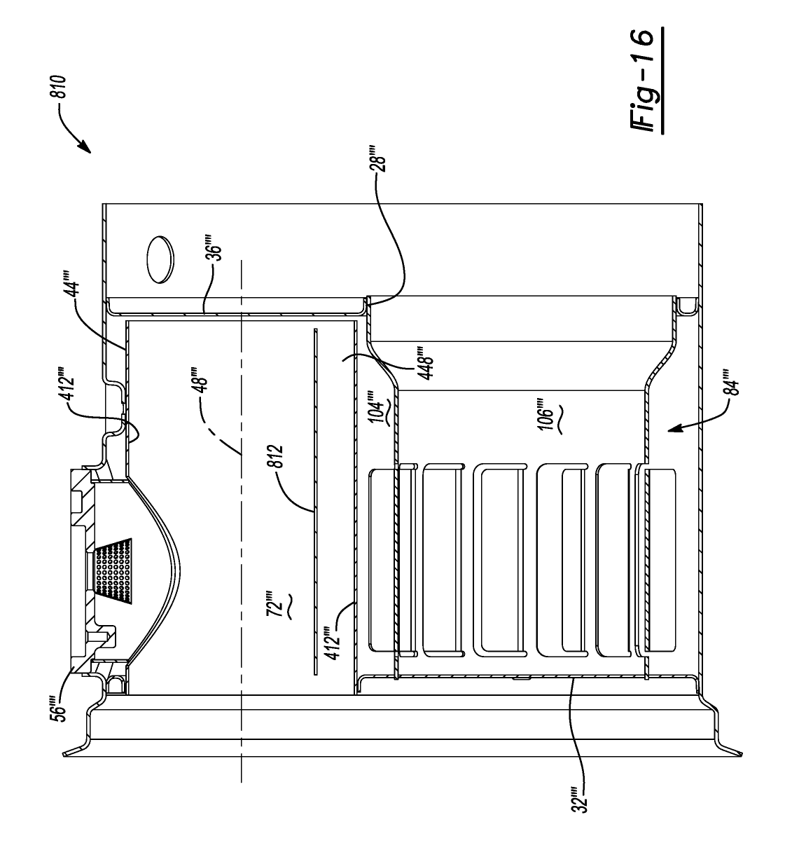

FIGS. 15 and 16 depict another alternate embodiment mix box 810. Mix box 810 is substantially similar to mix boxes 10, 510, and 610. Similar elements will be identified like reference numerals including a quadruple prime suffix. Mix box 810 differs from the others identified in that the first stage mixer is removed and a perforated plate 812 is positioned within decomposition tube 44””. Perforated plate 812 is a substantially rectangular, thin metal sheet extending offset and parallel to longitudinal axis 48”” of decomposition tube 44””. Perforated plate 812 has a width W substantially similar to impingement plate to 320. As such, perforated plate 812 engages inner surface 412”” of decomposition tube 44”” to define first chamber 72”” and bypass flow path 448””. The perforations increase the surface area of plate 812 and enhance evaporation of injected reductant.

FIG. 15A represents alternate embodiment plate 812a. Plate 812a is substantially the same as plate 812 with the exception that plate 812a does not include perforations. The remaining features and functions are similar to those previously described in relation to plate 812.

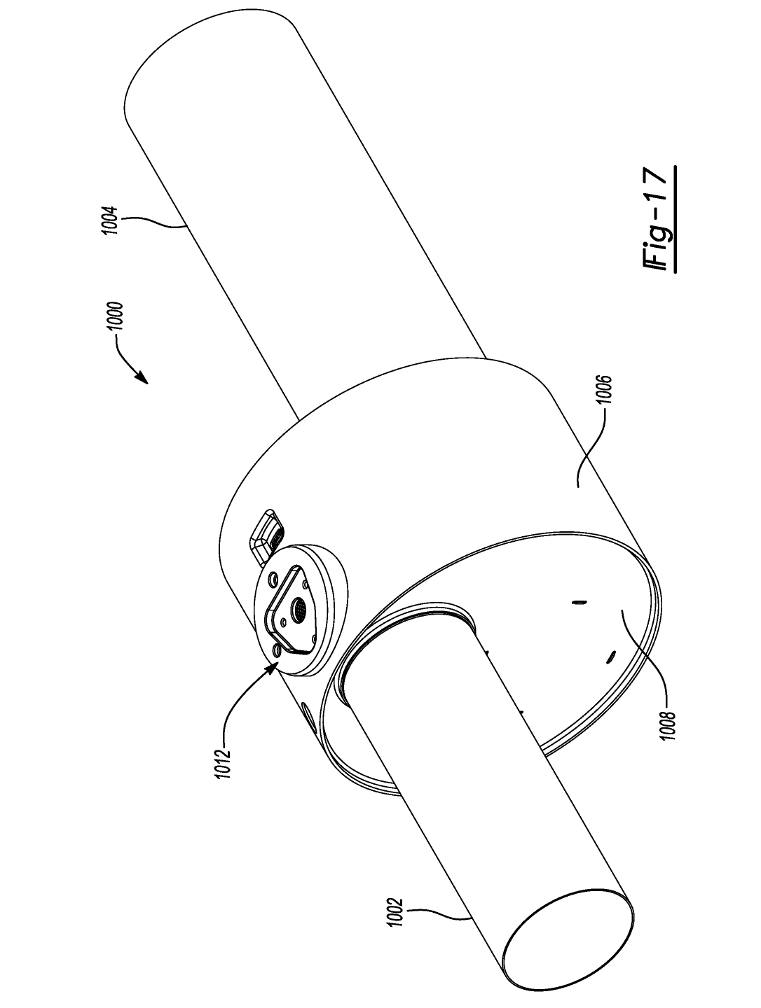

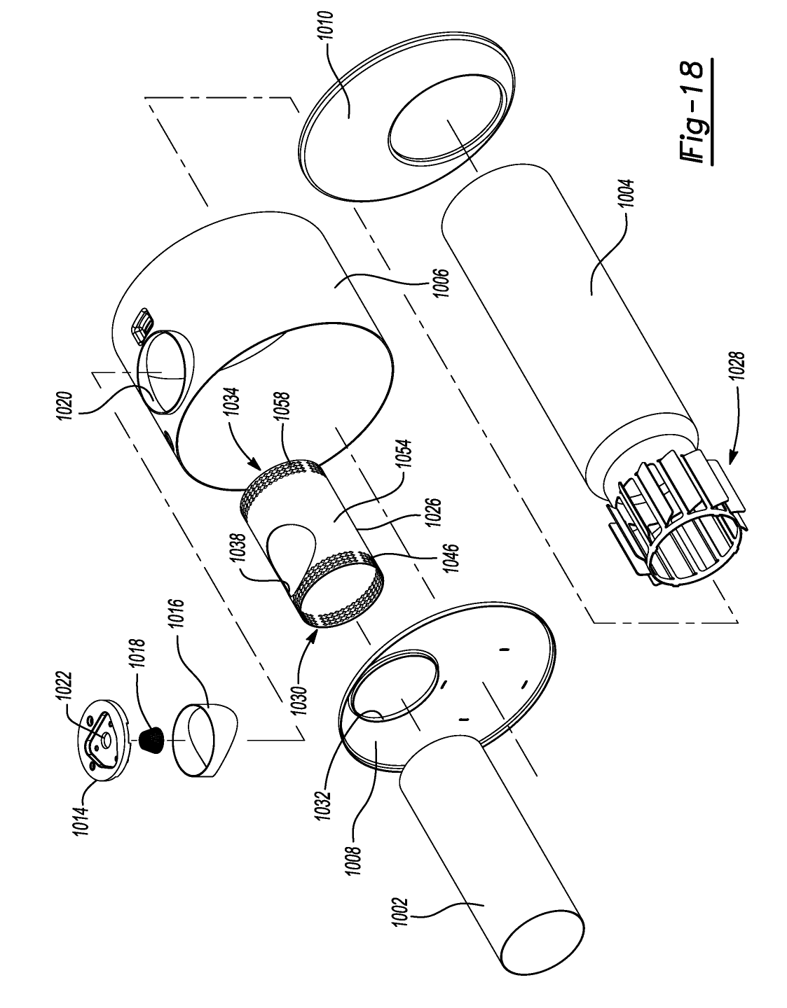

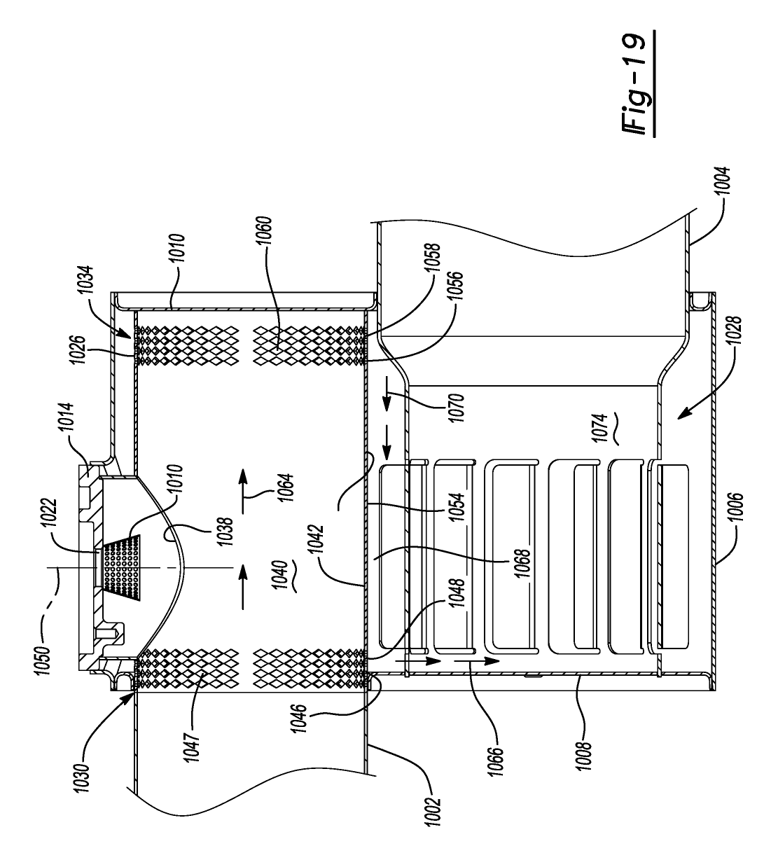

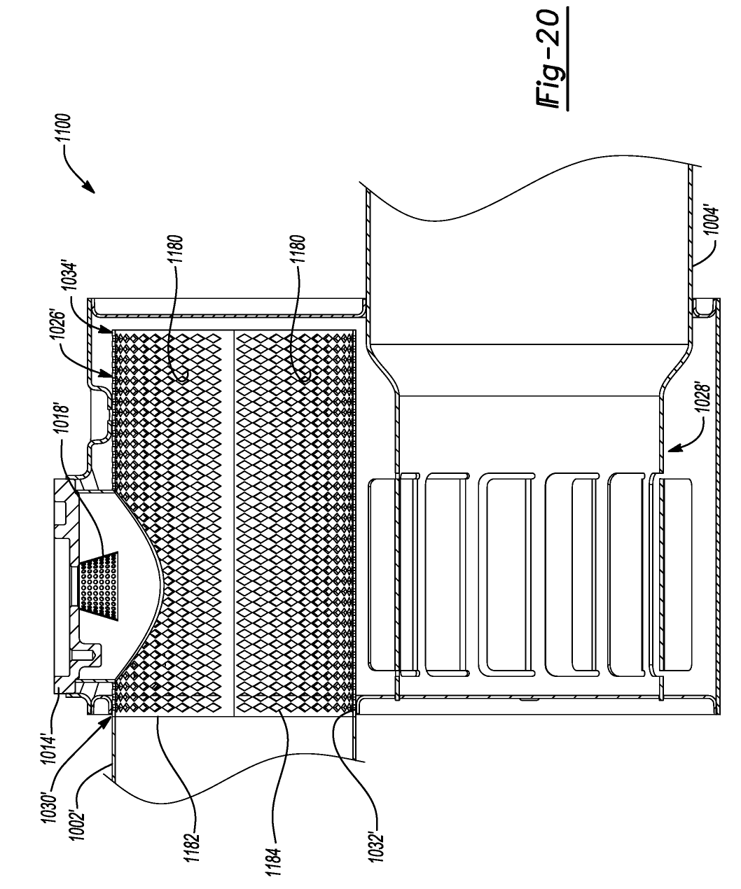

With reference to FIGS. 17-19, a single inlet mix box is shown at reference numeral 1000. Mix box 1000 is in fluid communication with an inlet pipe 1002 and an outlet pipe 1004. Mix box 1000 includes a housing 1006, a first end cap 1008, and a second end cap 1010. An injector mount 1012 is fixed to housing 1006. Injector mount 1012 includes a mounting plate 1014 and a tube 1016 coupled thereto. An optional shield 1018 is also included. Housing 1006 includes an aperture 1020 aligned with an aperture 1022 extending through mounting plate 1014.

Within housing 1006, a decomposition tube 1026 and a second stage mixer 1028 are disposed. Decomposition tube 1026 includes a first end 1030 fixed to first end cap 1008 and aligned with an inlet 1032 extending through first end cap 1008. Decomposition tube 1026 includes an opposite second end 1034 that is spaced apart from second end cap 1010 in similar fashion to the embodiments previously described. Decomposition tube includes an aperture 1038 transversely extending therethrough that is aligned with aperture 1020 extending through housing 1006 such that reductant from an injector assembly (not shown) may enter a first chamber 1040 defined by an inner surface 1042 of decomposition tube 1026.

Decomposition tube 1026 includes a first zone 1046 including a plurality of apertures or perforations 1047 extending therethrough. First zone 1046 extends axially from first end 1030 to a location 1048 positioned upstream from an axis of reductant injection identified at reference numeral 1050. Decomposition tube 1026 includes a second zone 1054 where decomposition tube 1026 is uninterrupted and free of perforations. Second zone axially extends from reference numeral 1048 to reference numeral 1056 that is positioned downstream of injection axis 1050. A third zone 1058 includes a plurality of apertures or perforations 1060 extending through the wall of the decomposition tube from reference numeral 1056 to second end 1034.

Second stage mixer 1028 is substantially similar to the second stage mixers previously described in relation to reference numerals 284, 84’, and 84”.

During operation, exhaust flows through inlet pipe 1002, inlet 1032 and into a first chamber 1062 within decomposition tube 1026 as indicated by first arrows 1064. Based on the proximity of second end 1034 to second end cap 1010, some of the exhaust flow is driven through the apertures or perforations 1047 located in the first zone 1046 as indicated by arrows 1066. This flow enters a second chamber 1068. Flow exiting second end 1034 of decomposition tube 1026 reverses direction and returns toward first end cap 1008 as identified by second arrows 1070. The flos identified as arrows 1006 and second arrows 1070 mix and enter a third chamber 1074 within second stage mixer 1028.

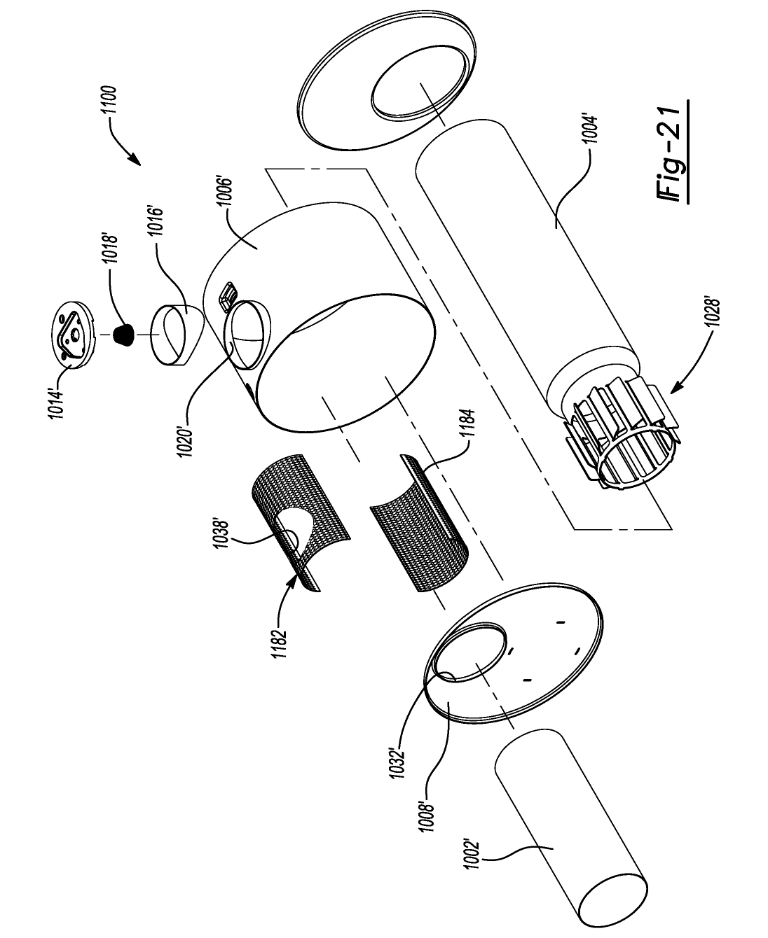

FIGS. 20 and 21 depict another embodiment mixer identified at reference numeral 1100. Mix box 1100 is substantially similar to mix box 1000. Accordingly, similar elements will be identified with like reference numerals including a prime suffix. The primary difference between mix box 1100 and mix box 1000 is that decomposition tube 1026’ includes apertures or perforations 1180 extending therethrough the entire length of decomposition tube 1026’. Decomposition tube1026’ may be constructed as an assembly of a first semi cylindrical panel 1182 and a second cylindrical panel 1184. First cylindrical panel 1182 includes aperture 1038’ flow receipt of injected reductant. It should be appreciated that the two-piece construction is merely exemplary, and a one-piece contiguous perforated tube is contemplated as being within the scope of the disclosure.

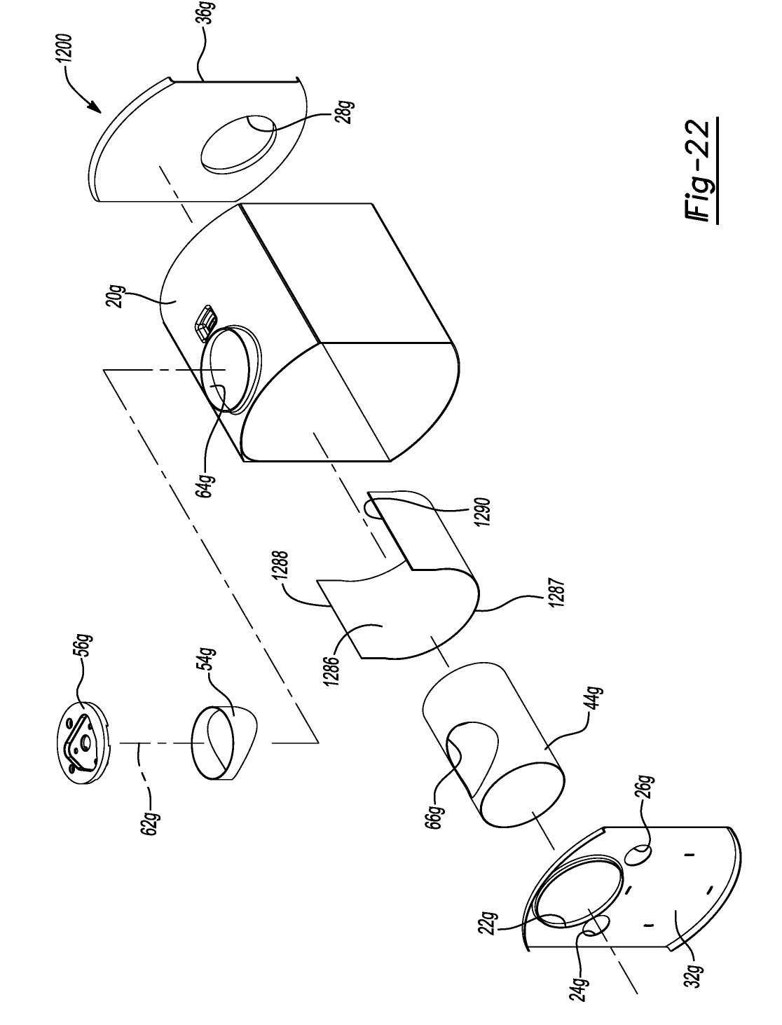

FIG. 22 presents another alternate embodiment mix box 1200. Mix box 1200 is substantially similar to mix box 10. Similar elements will be identified with like reference numerals including a “g” suffix. One difference between mix box 1200 and mix box 10 is that a diverter panel 1285 is positioned within housing 20g proximate decomposition tube 44g. Diverter panel 1285 is preferably constructed from a thin metal sheet and having a generally semicylindrical shape. Diverter panel 1285 includes a first end 1286 and an opposite second end 1287 fixed to second end cap 36g. Diverter panel 1286 includes a first edge 1288 fixed to an inner surface of housing 20g and an opposing second edge 1290 fixed to the inner surface of housing 20g. Diverter panel 1285 is oriented within housing 20g such that first edge 1288 and second edge 1290 rely on a common plane that extends orthogonally to injection axis 62g.

It should be noted that housing 20g is shaped differently than a right circular cylinder. The shape may be useful for packaging purposes in a vehicle or for changing the internal gas flow patterns within mix box 1200. Any one of the previously described mix boxes may include a differently shaped housing without departing from the scope of the present disclosure.

It is particularly envisioned that the concepts previously described may be characterized as combinations of interchangeable components. For instance, a mix box including a decomposition tube and a mixer outside of the decomposition tube may be used as a system without the need for other elements described in the specification, such as a first stage mixer. While the embodiments depicted show the injector assembly mounted on the side of the housing, this need not be the case for any embodiment. First stage and second stage mixers of all types are contemplated as being possibly useful within a system of the present disclosure. In other examples, a mix box including an atomizer without an impingement plate and a mix box including an impingement plate without an atomizer are within the scope of the present disclosure. While some embodiments discuss multiple housing inlets and bypass flow paths, not all mix boxes of the present disclosure require such features.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mix box comprising:
a housing including a first inlet, a second inlet, and an outlet;
first, second, and third chambers positioned within the housing;
a decomposition tube positioned within the housing and defining the first chamber, the decomposition tube including a first end in fluid communication with the first inlet and a second end spaced apart from the housing, wherein a first flow path extends a first direction from the first inlet through the decomposition tube, wherein a gap is provided between the second end of the decomposition tube and the housing to define a second flow path extending in a second direction opposite the first direction in the second chamber outside of the decomposition tube,
the second inlet being in fluid communication with the second chamber defining a third flow path bypassing the decomposition tube and extending in the first direction; and
a mixer positioned within the housing and including an opening in communication with the second chamber, the mixer defining a third chamber therein, the third chamber being in fluid communication with the outlet,
wherein the second flow path and the third flow path intersect one another in opposite directions within the second chamber upstream of the mixer.

2. The mix box of claim 1, further comprising another mixer positioned within the decomposition tube.

3. The mix box of claim 2, wherein the another mixer includes a plurality of blades.

4. The mix box of claim 1, wherein the housing includes an injector mount configured to couple an injector assembly to the mix box.

5. The mix box of claim 4, wherein the injector mount includes an aperture configured to receive reductant injected along an injection axis, wherein the injection axis extends substantially perpendicular to the first direction, wherein the housing includes a first end cap and a second end cap extending substantially parallel to the first end cap.

6. The mix box of claim 5, wherein the second chamber extends axially from the first end cap to the second end cap and is positioned between the decomposition tube and the another mixer.

7. The mix box of claim 1, further comprising an atomizer positioned within the decomposition tube.

8. The mix box of claim 7, wherein the atomizer is shaped as a flat plate including a plurality of apertures, the flat plate being positioned proximate the first end of the decomposition tube.

9. The mix box of claim 8, further comprising an impingement plate positioned within the decomposition tube and coupled to the atomizer.

10. The mix box of claim 9, wherein the atomizer and the impingement plate are constructed as a one-piece monolithic member.

11. A mix box comprising:
a housing including a first inlet, a second inlet, a third inlet and an outlet;
first, second, and third chambers positioned within the housing;
a decomposition tube positioned within the housing and defining the first chamber, the decomposition tube including a first end in fluid communication with the first inlet and a second end spaced apart from the housing, wherein a first flow path extends a first direction from the first inlet through the decomposition tube, wherein a gap is provided between the second end of the decomposition tube and the housing to define a second flow path extending in a second direction opposite the first direction in the second chamber outside of the decomposition tube,
the second inlet being in fluid communication with the second chamber defining a third flow path bypassing the decomposition tube and extending in the first direction;
the third inlet being in fluid communication with the first chamber and configured to receive reductant injected along an injection axis, wherein the injection axis extends substantially perpendicular to the first direction; and
a mixer positioned within the housing and including an opening in communication with the second chamber, the mixer defining a third chamber therein, the third chamber being in fluid communication with the outlet,
wherein the second flow path and the third flow path intersect one another in opposite directions within the second chamber upstream of the mixer.

12. The mix box of claim 11, wherein the housing includes an injector mount configured to couple an injector assembly to the mix box.

13. The mix box of claim 12, wherein the housing includes an injector mount having an aperture in fluid communication with the third inlet.

14. The mix box of claim 11, further comprising another mixer positioned within the decomposition tube.

15. The mix box of claim 14, wherein the another mixer includes a plurality of blades.

16. The mix box of claim 11, further comprising an atomizer positioned within the decomposition tube.

17. The mix box of claim 16, wherein the atomizer is shaped as a flat plate including a plurality of apertures, the flat plate being positioned proximate the first end of the decomposition tube.

18. The mix box of claim 17, further comprising an impingement plate positioned within the decomposition tube and coupled to the atomizer.

19. The mix box of claim 18, wherein the atomizer and the impingement plate are constructed as a one-piece monolithic member.

20. The mix box of claim 14, wherein the housing includes a first end cap and a second end cap extending substantially parallel to the first end cap, wherein the second chamber extends axially from the first end cap to the second end cap and is positioned between the decomposition tube and the another mixer.
